(19) United States
(12) Patent Application Publication
(10) Pub. No.: US 2017/0350713 A1
(43) Pub. Date: Dec. 7, 2017

(54) MAP UPDATE SYSTEM FOR AUTOMATED VEHICLES

(71) Applicant: Delphi Technologies, Inc., Troy, MI (US)

(72) Inventors: Gaurav Bhatia, Pittsburgh, PA (US); Jong Ho Lee, Pittsburgh, PA (US); Junqing Wei, Bridgeville, PA (US)

(21) Appl. No.: 15/171,148

(22) Filed: Jun. 2, 2016

(51) Int. Cl. G01C 21/32; G05D 1/00; G01C 21/36

(52) U.S. Cl. CPC G01C 21/32; G01C 21/3602; G05D 1/0088

(57) ABSTRACT

A map-data update system suitable for use by automated vehicles includes a digital-map, an imager-device, and a controller. The digital-map is used to indicate an expected-position of a traffic-signal relative to a map-location of a host-vehicle. The imager-device is suitable to install on the host-vehicle. The imager-device is used to determine an actual-position of the traffic-signal relative to a present-location of the host-vehicle. The controller is in communication with the digital-map and the imager-device. The controller issues an update-request to update the digital-map when the actual-position differs from the expected-position by greater than an error-threshold.

### TECHNICAL FIELD OF INVENTION

This disclosure generally relates to a map-data update system suitable for use by automated vehicles, and more particularly relates to a system that issues an update-request to update the digital-map when the location of a traffic-signal has changed.

### BACKGROUND OF INVENTION

It is known that an automated-vehicle detects light-color emitted by a traffic signal in order to determine how the automated-vehicle should be operated. For example, the automated-vehicle travels through an intersection when the traffic-signal is green, and the automated-vehicle stops when the traffic-signal is red. In order to assist the automated-vehicle to more effectively detect the traffic-signal, it has been suggested that a digital-map could include an indication of an expected-position of a traffic-signal. Having prior knowledge of the expected-location of a traffic-light may also be used by an automated-vehicle to determine when the line-of-site to the traffic light is obstructed, by a truck for example. However, if some event such as construction or natural disaster caused the actual-position of a traffic-signal to change, the process of manually updating the digital-map based on input from, for example, a construction-company employee or government official may not be timely or completely reliable.

### SUMMARY OF THE INVENTION

In accordance with one embodiment, a map-data update system suitable for use by automated vehicles is provided. The system includes a digital-map, an imager-device, and a controller. The digital-map is used to indicate an expected-position of a traffic-signal relative to a map-location of a host-vehicle. The imager-device is suitable to install on the host-vehicle. The imager-device is used to determine an actual-position of the traffic-signal relative to a present-location of the host-vehicle. The controller is in communication with the digital-map and the imager-device. The controller issues an update-request to update the digital-map when the actual-position differs from the expected-position by greater than an error-threshold.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a map-data update system in accordance with one embodiment; and

FIG. 2 is a traffic scenario encountered by the system of FIG. 1 in accordance with one embodiment.

### DETAILED DESCRIPTION

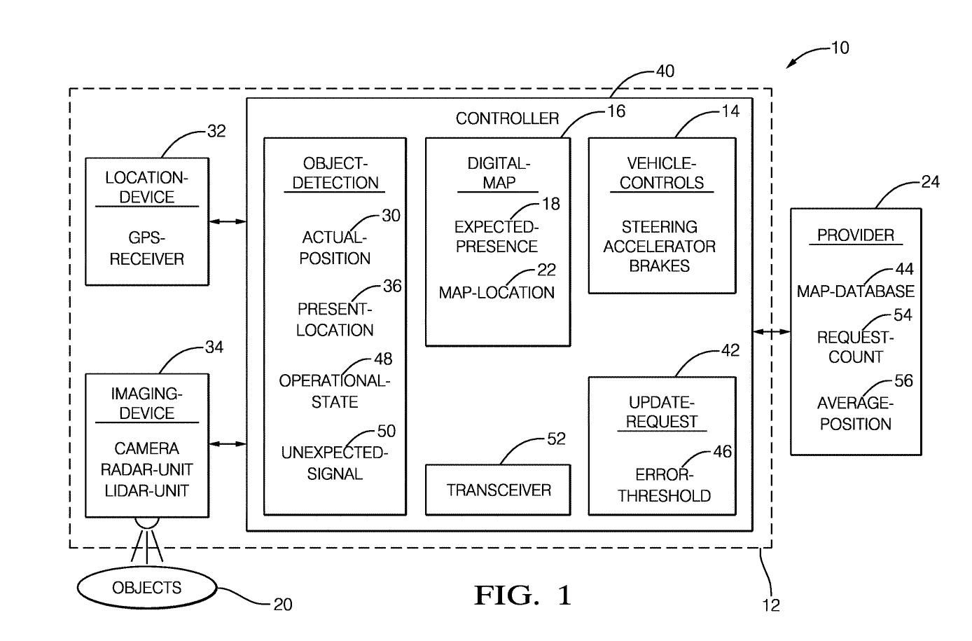

FIG. 1 illustrates a non-limiting example of a map-data update system 10, hereafter referred to as the system 10, which is suitable for use by automated vehicles, in particular a host-vehicle 12. While the teachings presented herein use fully-automated or autonomous (i.e. driverless) vehicles as in the non-limiting examples where a computer operates the vehicle-controls 14 of the host-vehicle 12, it is contemplated that the advantages of the system 10 described herein are applicable when a vehicle is being operated in a manual mode where an operator (not shown) operates the vehicle-controls 14.

The system 10 includes a digital-map 16 that indicates an expected-position 18 of a traffic-signal 20 (i.e. traffic-light) relative to a map-location 22 of the host-vehicle 12. While the digital-map 16 is shown as being located within the host-vehicle 12, it is contemplated that alternatively the digital-map 16 could be stored ‘in the cloud’ for access by the host-vehicle. More likely, a copy of the digital-map 16 will received from a provider 24 of map data, and be stored in the host-vehicle 12 for quick and reliable access. However, the digital-map 16 is expected to be periodically (e.g. daily or weekly) updated so the latest information is available to operate the host-vehicle 12.

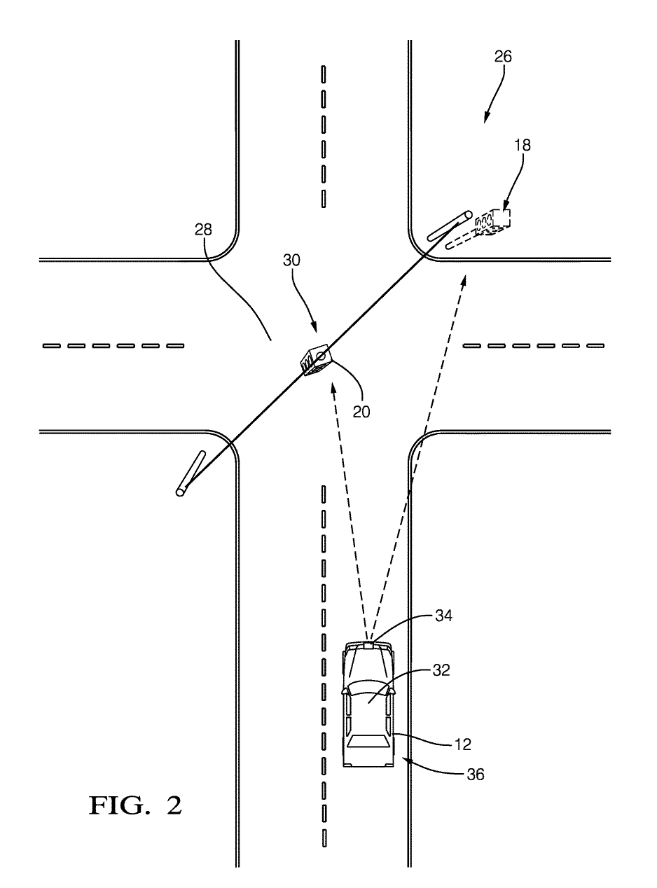

FIG. 2 illustrates a non-limiting example of a traffic-scenario 26 that may be encountered by the host-vehicle 12. The expected-position 18 of the traffic-signal 20 in this example is atop a post adjacent to the intersection 28. This expected-position 18 is based on information from the digital-map 16, which may be indicated by world coordinates, e.g. latitude, longitude, and elevation. However, due to construction activity for example, the traffic-signal 20 has been relocated so the actual-position 30 of the traffic-signal 20 is now suspended over the middle of the intersection 28 as illustrated. In order to determine the map-location 22 so the expected-location 18 and the actual-position 30 can be indicated and communicated, the system 10 may include a location-device 32 such as a global-position-system-receiver (GPS-receiver), as will be recognized by those in the art.

In order for the system 10 to determine that the traffic-signal 20 is not at the expected-position 18, and is located at the actual-position 30, the host-vehicle is equipped with imager-device 34 suitable to install on the host-vehicle 12. By way of example and not limitation, the imager-device 34 may be a camera, lidar-unit, or any combination of sensors suitable to detect the actual-location 30 of the traffic-signal 20 and what color of light is being emitted by the traffic-signal 20. That is, the imager-device 34 is used to determine the actual-position 30 of the traffic-signal 20 relative to a present-location 36 of the host-vehicle 12 indicated by the location-device 32. Ideally, the present-location 36 and the map-location 22 match. However, it is recognized that the present-location 36 (i.e. the actual GPS coordinates) of the host-vehicle 12 may not perfectly match the map-location (i.e. where on the map the host-vehicle 12 is presumed to be located). It is contemplated that if there is a persistent slight difference or offset between the expected-position 18 and the actual-position 30, less than a quarter-meter (0.25 m) for example, then the system 10 may be further configured to learn and apply a location-offset to the present-location 36 and/or the map-location 22 to compensate for an apparent error in the location-device 32.

Referring again to FIG. 1, the system 10 includes a controller 40 in communication with the digital-map 16 and the imager-device 34. The controller 40 may include a processor (not specifically shown) such as a microprocessor or other control circuitry such as analog and/or digital control circuitry including an application specific integrated circuit (ASIC) for processing data as should be evident to those in the art. The controller 40 may include memory (not specifically shown), including non-volatile memory, such as electrically erasable programmable read-only memory (EEPROM) for storing the digital-map 16, one or more routines, thresholds, and captured data. The one or more routines may be executed by the processor to perform steps for determining the expected-position 18 and the actual-position 30 based on signals received by the controller 40 from the location-device 32, the imager-device 34, and the provider 24 as described herein.

If the difference between the expected-position 18 and the actual-position 30 is large enough to not be caused by GPS errors as suggested above, then it may be necessary to update the digital-map 16. Advantageously, the update may be accomplished if the controller 40 issues an update-request 42 to the provider 24 to update the map-database 44 maintained by the provider 24, which will result in a update to the digital-map 16 being sent back by the provider 24. This arrangement is particularly advantageous as other-vehicles (not shown) that will travel through the intersection 28 at some later time, e.g. the next day, will receive an updated version of digital-map from the provider 24 prior to encountering the intersection 28. Alternatively, or in addition to sending the update-request 42 to the provider 24, the update-request 42 may initiate operating the controller 40 so that the update is made directly to the digital-map 16 by the controller 40. In either case, the update-request 42 is made when the actual-position 30 differs from the expected-position 18 by greater than an error-threshold 46, 0.25 m for example.

In addition to detecting when the traffic-signal 20 has been moved or relocated, the system 10, or more specifically the controller 40, may be further configured to issue the update-request 42 to update the digital-map 16 when the traffic-signal 20 is not operational, i.e. the operational-state 48 is ‘out-of-order’. This information can forewarn other-vehicles that the traffic-signal 20 is not working so, for example, the intersection 28 can be avoided by taking an alternate route. In addition, this information may be forwarded to the proper entity or authorities so, for example, a police officer may be dispatched to direct traffic through the intersection, and/or a repair-crew can be dispatched to repair the traffic-signal.

In contrast to the controller 40 sending or issuing the update-request 42 when the traffic-signal 20 is determined to be at an actual-position 30 other than the expected-position 18, the controller may be further configured to issue the update-request 42 to update the digital-map 16 when an unexpected-signal 50 not present on the digital-map 16 is detected. That is, if the presence of a traffic-signal is detected and the digital-map 16 has no record of any corresponding traffic-signal within a substantial distance, e.g. twenty-five meters (25 m) from the actual-position 30 of the unexpected-signal 50, then the update-request 42 may be used to document the presence of a new instance of traffic-signal in the map-database 44. It is contemplated that the unexpected-signal 50 may be a newly installed traffic-signal, or a traffic-signal that has been in place for some time that for some reason was never documented in the map-database 44.

In order for the controller 40 to communicate with the provider 24, the system may include a transceiver 52 suitable to install on the host-vehicle 12. The transceiver 52 may be used to transmit the update-request 42 to the provider 24 of the digital-map 16, and/or receive updates of the digital-map 16 from the provider 24. The transceiver 52 may be a WI-FI® type transceiver that establishes a communications link with the provider 24 when a suitable WI-FI® network is available, or the transceiver 52 may be a cellular-phone network type transceiver, or a satellite transceiver. Communications between the controller 40 an the provider 24 may be established continuously if available, or may be established on a periodic basis such as in the middle of the night each day.

As noted above, it is recognized that errors can occur in coordinate values used to indicate the present-location 36. In order to prevent erroneous or malicious revisions to the map-database 44, the provider 24 may require that a minimum number of similar instances of the update-request 42 are received. That is, the provider 24 may update the digital-map 16 only after a plurality of update-requests (e.g. a request-count 54 more than seven) for the same instance of the traffic-signal 20 is received by the provider 24. The provider 24 may further require that each of the plurality of update-requests is received from a distinct instance of the controller 40, i.e. from a different host-vehicle or different customer identification, before accepting the update-request 42 as valid and revising the digital-map 16.

In further view of the recognition that errors can occur in coordinate values used to indicate the present-location 36, the provider may update the digital-map 16 based on an average-position 56 that is a calculated average of multiple instances of the actual-positions from the plurality of update-requests. It is expected that by basing the update of the digital-map 16 there will be fewer erroneous instance of map-update systems determining that the actual-position 30 differs from the expected-position 18 by greater than the error-threshold 46

Accordingly, a map-data update system (the system 10), a controller 40 for the system 10 and a method of operating the system 10 is provided. The system 10 provides a reliable way for a map-database 44 to be continuously checked for accuracy and quickly updated when the expected-position 18 of a traffic-signal does not reasonably match the actual-position 30 determined by the controller 40 of the host-vehicle 12. The system 10 thereby removes the burden on government and/or construction companies to provide manual updates of the map-database 44.

While this invention has been described in terms of the preferred embodiments thereof, it is not intended to be so limited, but rather only to the extent set forth in the claims that follow.

We claim:

1. A map-data update system suitable for use by automated vehicles, said system comprising:
a digital-map used to indicate an expected-position of a traffic-signal relative to a map-location of a host-vehicle;
an imager-device suitable to install on the host-vehicle, said imager-device used to determine an actual-position of the traffic-signal relative to a present-location of the host-vehicle;
a controller in communication with the digital-map and the imager-device, wherein the controller issues an update-request to update the digital-map when the actual-position differs from the expected-position by greater than an error-threshold.

2. The system in accordance with claim 1, wherein the controller is further configured to issue the update-request to update the digital-map when the traffic-signal is not operational.

3. The system in accordance with claim 1, wherein the controller is further configured to issue the update-request to update the digital-map when an unexpected-signal not present on the digital-map is detected.

4. The system in accordance with claim 1, wherein the system includes a transceiver suitable to install on the host-vehicle, said transceiver used to transmit the update-request to a provider of the digital-map.

5. The system in accordance with claim 4, wherein the provider updates the digital-map after a plurality of update-requests for the traffic-signal is received by the provider.

6. The system in accordance with claim 5, wherein the provider updates the digital-map based on an average-position that is an average of actual-positions from the plurality of update-requests.
